(19) United States
(12) Patent Application Publication
(10) Pub. No.: US 2026/0003732 A1
(43) Pub. Date: Jan. 1, 2026

(54) TURBO REDUNDANT ARRAY OF INDEPENDENT NOT-AND OPERATIONS ACROSS PLANES OF A MEMORY SYSTEM

(71) Applicant: Micron Technology, Inc., Boise, ID (US)

(72) Inventors: Naveen Bolisetty, Suryapet (IN); Varaprasad Ramoju, East Rajamahendravaram (IN); Prashanth Reddy Enukonda, Bangalore (IN); Michael William Winterfeld, Firestone, CO (US)

(21) Appl. No.: 19/243,654

(22) Filed: Jun. 19, 2025

Related U.S. Application Data
(60) Provisional application No. 63/666,581, filed on Jul. 1, 2024.

(51) Int. Cl. G06F 11/10

(52) U.S. Cl. CPC G06F 11/1076

(57) ABSTRACT

Methods, systems, and devices for turbo redundant array of independent not-and (RAIN) operations across planes of a memory system are described. A memory system may perform a turbo RAIN recovery procedure to correct multiple uncorrectable errors in a page stripe of the memory system. As part of the turbo RAIN recovery procedure, the memory system may calculate a reference value based on a combination of good data within the page stripe. The calculation of the reference value may be the same irrespective of which error of the multiple uncorrectable errors is being corrected, and the memory system may store the calculated reference value for a duration until the multiple uncorrectable errors of the page stripe are corrected. For each error that is corrected, the memory system may fetch the stored reference value for performing error correction.

### CROSS REFERENCE

The present Application for Patent claims priority to U.S. Patent Application No. 63/666,581 by Bolisetty et al., entitled “TURBO REDUNDANT ARRAY OF INDEPENDENT NOT-AND OPERATIONS ACROSS PLANES OF A MEMORY SYSTEM” filed Jul. 1, 2024, which is assigned to the assignee hereof, and which is expressly incorporated by reference in its entirety herein.

### TECHNICAL FIELD

The following relates to one or more systems for memory, including turbo redundant array of independent not-and (RAIN) operations across planes of a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports turbo redundant array of independent not-and (RAIN) operations across planes of a memory system in accordance with examples as disclosed herein.

FIGS. 2-4 show examples of architectures that supports turbo RAIN operations across planes of a memory system in accordance with examples as disclosed herein.

FIG. 5 shows a block diagram of a memory system that supports turbo RAIN operations across planes of a memory system in accordance with examples as disclosed herein.

FIG. 6 shows a flowchart illustrating a method or methods that support turbo RAIN operations across planes of a memory system in accordance with examples as disclosed herein.

### DETAILED DESCRIPTION

Some memory systems may perform scans for errors, such as uncorrectable errors, to protect against data loss. In some cases, memory systems may deploy recovery procedures in response to detecting one or more uncorrectable errors at a page stripe of a memory device. The recovery procedures may include, for example, a redundant array of independent not-AND (RAIN) recovery procedure. An uncorrectable error may refer to an error that may not be correctable using one or more initial correction procedures, such as, for example, error correction code (ECC), or other procedures. In some examples, the memory system may identify that the page stripe has two or more uncorrectable errors, and the RAIN recovery procedure may fail to correct the multiple uncorrectable errors in the page stripe. For example, the RAIN recovery procedure may be based on a combination (e.g., an XOR) of good data (e.g., data without error) in the page stripe. However, in cases where multiple errors are present in the page stripe, there may be insufficient information for the memory system to correct the errors using RAIN.

In accordance with examples as described herein, a memory system may perform a turbo RAIN recovery procedure to correct multiple uncorrectable errors in a page stripe of the memory system. As part of the turbo RAIN recovery procedure, the memory system may calculate a reference value based on a combination of good data within the page stripe. The memory system may correct or recover data based on the reference value and recovery data associated with the error. In some examples, the calculation of the reference value is the same irrespective of which error of the multiple uncorrectable errors is being corrected. Thus, the memory system may store the calculated reference value for a duration until the multiple uncorrectable errors of the page stripe are corrected. For each error of the multiple uncorrectable errors that the memory system corrects using the turbo RAIN recovery procedure, the memory system may calculate respective recovery data and fetch the stored reference value rather than performing redundant calculations of the reference value, which may support reduced processing, reduced latency of memory access, and more efficient error correction at the memory system.

In addition to applicability in memory systems as described herein, techniques for turbo RAIN operations across planes of a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing processing and latency associated with error recovery operations at the memory system, thereby supporting more complex and/or power intensive applications such as AI, AR, VR, and gaming, among other benefits.

In addition to applicability in memory systems as described herein, techniques for turbo RAIN operations across planes of a memory system may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by eliminating computation redundancy and reducing a strain on the memory system to perform excess processing and/or computation, which may result in lowered production emissions and may extend the life of electronic devices thereby reducing electronic waste, among other benefits.

Features of the disclosure are illustrated and described in the context of systems, devices, and circuits. Features of the disclosure are further illustrated and described in the context of architectures, block diagrams, and flowcharts.

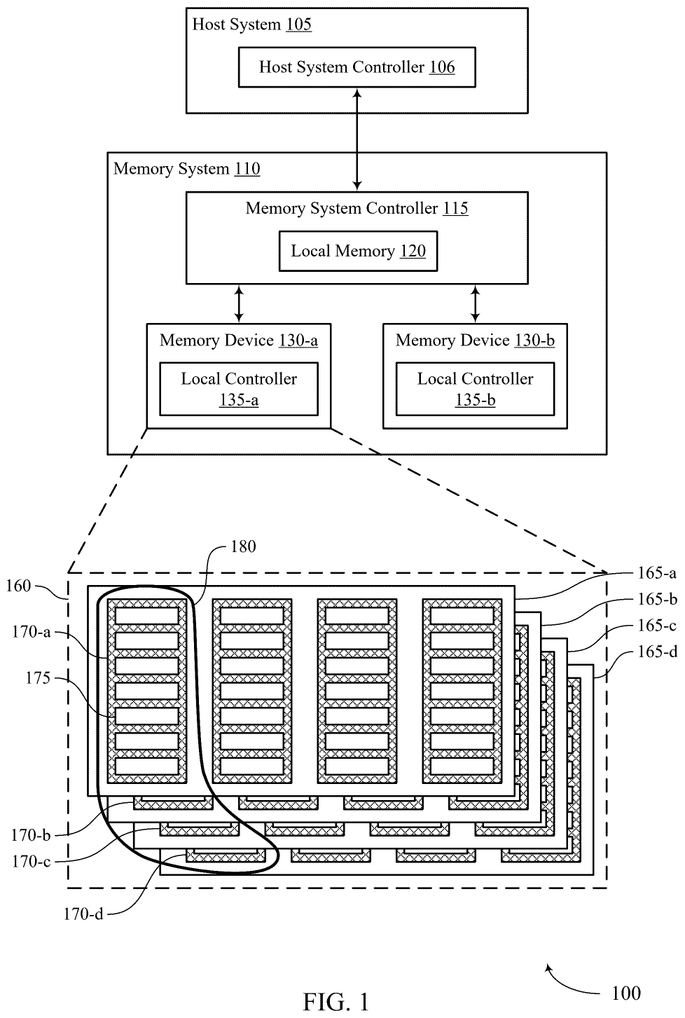

FIG. 1 shows an example of a system 100 that supports turbo RAIN operations across planes of a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

Some memory systems 110 may perform scans for errors, such as uncorrectable errors that are not corrected by ECC operations, to protect against data loss. In some cases, a memory system 110 may deploy recovery procedures in response to detecting one or more uncorrectable errors at a page stripe of a memory device, such as a RAIN recovery procedure. In some examples, the memory system 110 may identify that the page stripe has two or more uncorrectable errors, and the RAIN recovery procedure may fail to correct the multiple uncorrectable errors in the page stripe. For example, the RAIN recovery procedure may be based on a combination (e.g., an XOR) of good data (e.g., data without error) in the page stripe. However, in cases where multiple errors are present in the page stripe, there may be insufficient information for the memory system 110 to correct the errors.

In accordance with examples as described herein, a memory system 110 may perform a turbo RAIN recovery procedure to correct multiple uncorrectable errors in a page stripe of the memory system 110. As part of the turbo RAIN recovery procedure, the memory system may calculate a reference value based on a combination of good data within the page stripe. In some examples, because the calculation of the reference value is the same irrespective of which error of the multiple uncorrectable errors is being corrected, the memory system 110 may store the calculated reference value for a duration until the multiple uncorrectable errors of the page stripe are corrected. For each error of the multiple uncorrectable errors that the memory system 110 corrects using the turbo RAIN recovery procedure, the memory system 110 may fetch the stored reference value rather than performing redundant calculations of the reference value, which may support reduced processing, reduced latency of memory access, and more efficient error correction of error conditions.

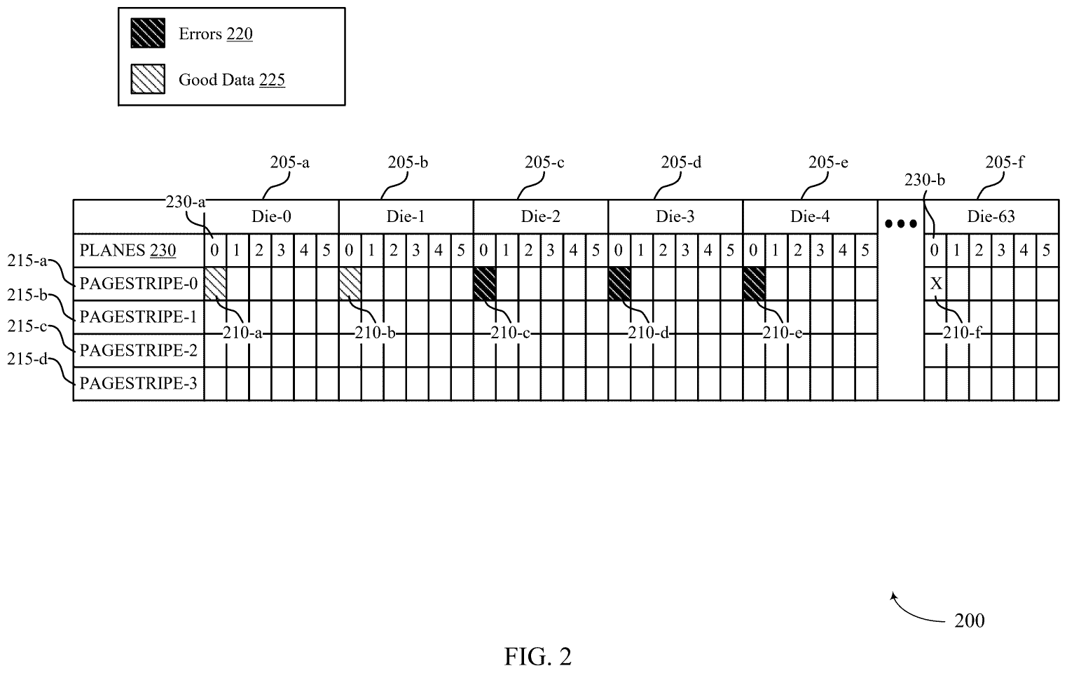

FIG. 2 shows an example of an architecture 200 that supports turbo RAIN operations across planes of a memory system in accordance with examples as disclosed herein. The architecture 200 may implement or may be implemented by aspects of the system 100. For example, the architecture 200 may include dies 205, which may be examples of dies 160 as described with reference to FIG. 1, and may include planes 230, which may be examples of planes 165 as described with reference to FIG. 1.

A page stripe 215 may include data portions 210 across a plurality of planes 230 and across a plurality of dies 205 that are concurrently accessed by a memory system. For example, a memory system may receive a command to read data from a page stripe (e.g., a page stripe 215-a, a page stripe 215-b, a page stripe 215-c, a page stripe 215-d). Based on receiving the command, the memory system may read data from the page stripe, and the data may include at least one or more data portions 210. Data portions 210 may each include one or more data transfer units (TUs). Each plane 230 (e.g., a plane 230-a) at each die 205 of the memory system may include a quantity of TUs (e.g., four TUs per plane 230). Each die 205 (e.g., a die 205-a, a die 205-b, a die 205-c, a die 205-d, a die 205-e, a die 205-f) may include a quantity of planes 230 (e.g., six planes per die 205).

In the example of FIG. 2, the memory system may read the page stripe 215-a including a first set of TUs (e.g., data portions 210) and a second set of TUs. The first set of TUs may include a data portion 210-c, a data portion 210-d, and a data portion 210-e, which may each include one or more errors 220 (e.g., may include a subset of data associated with errors). In some examples, the errors 220 may be uncorrectable errors (e.g., uncorrectable error correction code (UECC) errors). The second set of TUs may include a data portion 210-c, a data portion 210-d, and a data portion 210-e, which may each include good data 225 (e.g., data without errors, data without uncorrectable errors).

In some examples, based on reading the data from the page stripe 215-a, the memory system may perform an error correction operation (e.g., ECC or some other type of correction operation). The memory system may detect the errors 220 associated with the first set of TUs based on performing the error correction operation. In some examples, the memory system may perform a die-based recovery operation in which the memory system attempts to correct the identified errors 220 in each plane of a first plane index (e.g., a plane index 0) across the multiple dies 205. The recovery operation may be a RAIN recovery operation (e.g., a die-based RAIN operation) and may be initiated by the memory system to correct the errors 220 included in the data portion 210-c, the data portion 210-d, and the data portion 210-e. As part of the RAIN recovery procedure, the memory system may attempt a correction of the data portion 210-c (e.g., a TU of the data portion 210-c). The memory system may perform a combination (e.g., an XOR) of the first set of TUs and the second set of TUs (e.g., the raw data from data portions 210 at plane index 0 that span the dies 205), according to Equation 1.

$$S = TU 0 ⊕ ( TU 1 ) raw ⊕ ( TU 2 ) raw ⊕ … ⊕ TUn - 2 \qquad ( 1 )$$

By performing the combination of the first set of TUs and the second set of TUs, the memory system may generate soft bit data (e.g., in accordance with soft decoding), and the memory system may store the soft bit data (e.g., S) at a data portion 210-f. The soft bit data may be stored in at least one data transfer unit of a plane 230-b of the plane index 0 and included in a final die 205-f of the multiple dies 205 of the page stripe 215-a.

In some cases, if multiple errors 220 are present at multiple TUs in the page stripe 215-a (e.g., at the data portion 210-c, the data portion 210-d, and the data portion 210-e as illustrated in FIG. 2), the RAIN recovery operation may experience a failure (e.g., may fail to correct the errors 220). Based on the RAIN recovery operation failing, or based on identifying the multiple errors 220 in the page stripe 215-a, or both, the memory system may initiate and perform a turbo RAIN recovery operation. The turbo RAIN recovery operation may include one or more additional computations and/or data collection in addition to those performed as part of a RAIN recovery operation. For example, as part of the turbo RAIN recovery operation, the memory system may calculate a reference value (e.g., to be stored in a reference buffer) and recovery data for performing correction of the multiple errors 220.

The reference value may be calculated based on a combination (e.g., an XOR) of the good data 225 in the page stripe 215-a (e.g., raw data from the second set of TUs containing good data 225). In the illustrative example of FIG. 2, the reference value may be an XOR of the data portion 210-a (e.g., raw data of the data portion 210-a) with the data portion 210-b (e.g., raw data of the data portion 210-b), and with other good data 225 located in data portions located at plane index 0 of other dies 205 (not shown) (e.g., including the die 205-f). In some cases, the reference value may be based on combining the soft bit data (e.g., which may be stored at the data portion 210-f within the plane 0 of the die 205-f) with the raw data from the second set of TUs containing good data 225. That is, the soft bit data may have been previously calculated and stored at plane index 0 of die 205-f (e.g., during the RAIN recovery operation or based on an initiation of the turbo RAIN recovery operation) and may be included in the XOR operation to generate the reference buffer. The memory system may calculate the reference value according to Equation 2.

$$\begin{matrix}X 0 {R}_{base} = {TU}_{0} ⊕ {TU}_{1} ⊕ {TU}_{5} ⊕ {TU}_{6} ⊕ {TU}_{7} ⊕ {TU}_{8} ⊕ {TU}_{9} \\ {TU}_{63}\end{matrix} … ⊕ \qquad ( 2 )$$

In Equation 2, XOR_{base} may be the reference value and TUₙ may be raw data from one or more TUs that include good data at plane index 0 of a die n of the multiple dies 205 spanning the page stripe 215-a. For example, TU₀ may be raw data from one or more TUs included in the data portion 210-a and TU₁ may be raw data from one or more TUs included in the data portion 210-b, and so on. In the example of Equation 2, there may be 64 dies 205 (e.g., TU₀ through TU₆₃). However, it is to be understood that a memory system may include any quantity of dies.

In accordance with the turbo RAIN recovery operation, the calculated reference value may be reused for correction of each of the errors 220 (e.g., which the memory system may correct in order, or according to a queue). Calculating the reference value may consume some time period (e.g., 302 microseconds, or some other calculation time depending on a quantity of TUs). As such, re-calculating the reference value once for each error may increase processing and latency as a quantity of uncorrectable errors increases, in some systems.

Thus, in accordance with examples described herein, the memory system may calculate the reference value once and may store the calculated reference value in memory (e.g., in a reference buffer). The memory system may correct each of the errors 220 (e.g., at the data portion 210-c, at the data portion 210-d, and at the data portion 210-e) using the stored reference value. The memory system may refrain from releasing, or overwriting, the value of the reference buffer until each of the errors 220 of the page stripe 215-a associated with the plane index 0 are corrected. In some examples, a duration for storing the calculated reference value at the reference buffer may be indicated by a host system, or may be a preconfigured value at the memory system. In some cases, for example based on the duration expiring, the memory system may overwrite the reference buffer with a second reference value for recovery of data stored in a third set of TUs, which may be associated with a different plane index (e.g., plane index 1) of the page stripe 215-a. That is, the calculated reference buffer may be applicable to errors 220 of data located at a first plane index (e.g., plane index 0) across dies 205. To correct errors 220 of a second plane index (e.g., plane index 1), the memory system may calculate a second reference value corresponding to the second plane index, and the second reference value may overwrite the first reference value in the reference buffer with the second reference value.

Correcting the errors 220 may be based on the reference value (e.g., a common reference value, the stored reference value) and TU-specific recovery data (e.g., TU-specific soft bit data) that is calculated separately for each error 220 that is corrected. In a first illustrative example, to perform correction on a first error associated with the data portion 210-c (e.g., one or more TUs of the data portion 210-c), the memory system may calculate first recovery data. The first recovery data may be based on a combination (e.g., an XOR) of the first set of TUs (e.g., raw data from the first set of TUs) that include the errors 220, but with the data portion 210-c (e.g., the one or more TUs of the data portion 210-c undergoing correction) excluded. That is, the combination may include raw data from a first subset of the first set of TUs different than the data portion 210-c. In the example of FIG. 2, the first subset of the first set of TUs may include raw data from the data portion 210-d and raw data from the data portion 210-e. To correct the error 220 associated with the data portion 210-c, the memory system may perform a combination (e.g., an XOR) of the calculated reference value with the first recovery data, according to Equation 3, where TU_{3raw}⊕TU_{4raw} (e.g., the XOR of the data portion 210-d with the data portion 210-e) corresponds to the first recovery data.

$$Soft bit data for TU 2 = X 0 {R}_{base} ⊕ {TU}_{3 raw} ⊕ {TU}_{4 raw} \qquad ( 3 )$$

In a second illustrative example, to perform correction on a second error associated with the data portion 210-d (e.g., one or more TUs of the data portion 210-d), the memory system may calculate second recovery data. The second recovery data may be based on a combination (e.g., an XOR) of the first set of TUs (e.g., raw data from the first set of TUs) that include the errors 220, but with the data portion 210-d (e.g., the one or more TUs of the data portion 210-d undergoing correction) excluded. That is, the combination may include raw data from a second subset of the first set of TUs different than the data portion 210-d. In the example of FIG. 2, the second subset of the first set of TUs may include raw data from the data portion 210-c and raw data from the data portion 210-e. To correct the error 220 associated with the data portion 210-d, the memory system may perform a combination (e.g., an XOR) of the calculated reference value with the second recovery data, according to Equation 4, where TU_{2raw}⊕TU_{4raw} (e.g., the XOR of the data portion 210-c with the data portion 210-e) corresponds to the second recovery data.

$$Soft bit data for TU 3 = X 0 {R}_{base} ⊕ {TU}_{2 raw} ⊕ {TU}_{4 raw} \qquad ( 4 )$$

The memory system may correct the errors based on (e.g., using) the calculated soft bit data. After correcting each of the errors 220 associated with the page stripe 215-a using the stored reference value and respective recovery data, the memory system may transmit the data (e.g., corrected data) of the page stripe 215-a to a host system. For example, in response to a command from the host system to read data from the page stripe 215-a, the memory system may perform a turbo RAIN recovery operation to correct the errors 220 prior to transmitting the data from the page stripe 215-a to the host system responsive to the command. By utilizing reuse of the reference value for error correction of the multiple errors 220 within the page stripe 215-a, the memory system may support reduced latency and faster memory access speeds, as well as reduced processing and power consumption by the memory system, due to performing fewer reference value computations (e.g., XOR operations).

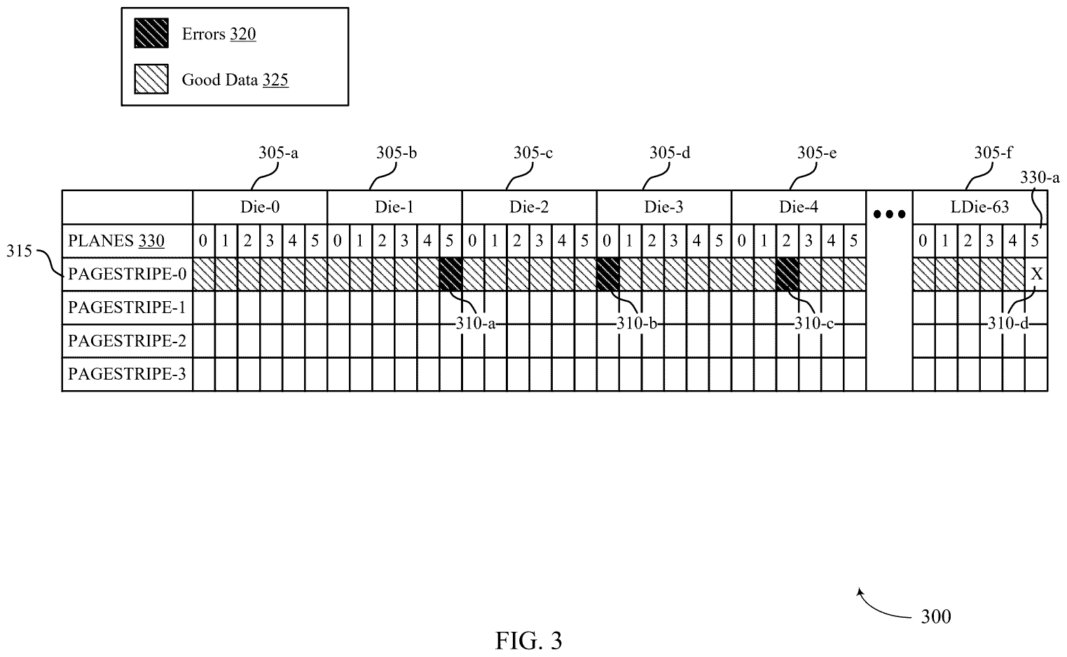

FIG. 3 shows an example of an architecture 300 that supports turbo RAIN operations across planes of a memory system in accordance with examples as disclosed herein. The architecture 300 may implement or may be implemented by aspects of the system 100. For example, the architecture 200 may include dies 305 (e.g., a die 305-a, a die 305-b, a die 305-c, a die 305-d, a die 305-e, a die 305-f), which may be examples of dies 160 as described with reference to FIG. 1, and may include planes 330, which may be examples of planes 165 as described with reference to FIG. 1.

A memory system may read data from a page stripe 315 and may identify errors 320 (e.g., uncorrectable errors) within data portions 310 of the page stripe 315. In some examples, the memory system may perform a plane-based RAIN operation to correct one or more errors 320. The memory system may read data from a first set of TUs (e.g., a data portion 310-a, a data portion 310-b, and a data portion 310-c) that includes errors 320 and from a second set of TUs that includes good data 325. The first set of TUs and the second set of TUs may be within multiple planes of the page stripe 315 and across multiple dies 305 of the memory system. Each die 305 may include one or more planes associated with one or more plane indexes (e.g., plane index 0 through plane index 5). In accordance with plane-based RAIN, the memory system may store soft bit data for the page stripe 315, which may be a combination of data stored across the first set of TUs and the second set of TUs, in a data portion 310-d (e.g., one or more TUs) of a final plane 330-a (e.g., of a die 305-f) of the multiple planes 330 of the page stripe 315.

As described with reference to FIG. 2, in accordance with a turbo RAIN recovery operation, the memory system may calculate a reference value, store the reference value in a reference buffer, and may correct each of the errors 320 (e.g., at the data portion 310-a, at the data portion 310-b, and at the data portion 310-c) using the stored reference value. The memory system may refrain from releasing, or overwriting, the value of the reference buffer until each of the errors 320 of the page stripe 315 (e.g., at each plane of the page stripe 315 across dies 305, irrespective of plane index) are corrected. In some cases, for example based on the duration expiring, the memory system may overwrite the reference buffer with a second reference value for recovery of data stored in a third set of TUs, which may be associated with the page stripe 215-b. That is, the calculated reference buffer may be applicable to errors 220 of data located at portions of data across planes 330 and across dies 305 of the page stripe 315 (e.g., which may correspond to a first page stripe index). To correct errors 320 of a second page stripe (e.g., a second page stripe index), the memory system may calculate a second reference value corresponding to the second page stripe (e.g., the second page stripe index), and the second reference value may overwrite the first reference value in the reference buffer.

The memory system may thereby utilize the reference value calculation and storage techniques described herein for both die-based turbo RAIN recovery operations as illustrated in FIG. 2 and plane-based turbo RAIN recovery operations as illustrated in FIG. 3, where the reference value is stored per plane index or per page stripe index, or both, based on the type of recovery operation.

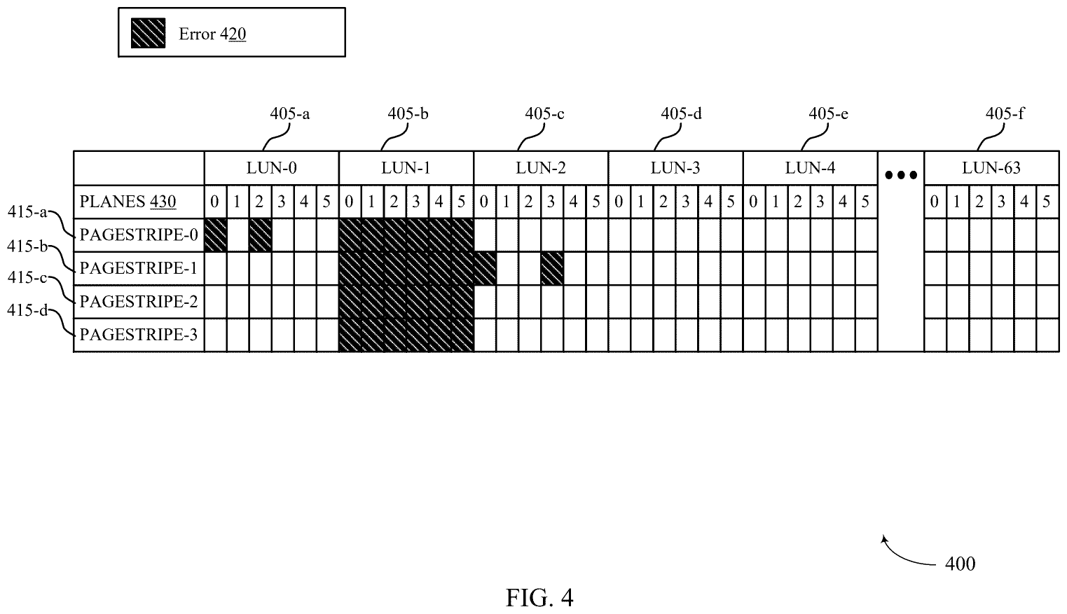

FIG. 4 shows an example of an architecture 400 that supports turbo RAIN operations across planes of a memory system in accordance with examples as disclosed herein. The architecture 400 may implement or may be implemented by aspects of the system 100. For example, the architecture 400 may include dies 405 (e.g., a die 405-a, a die 405-b, a die 405-c, a die 405-d, a die 405-e, a die 405-f), which may be examples of dies 160 as described with reference to FIG. 1, and may include planes 430, which may be examples of planes 165 as described with reference to FIG. 1.

In some examples, a memory system may identify that a die 405-b of the memory system is experiencing a die-level failure. For example, based on identifying the failure of the die 405-b, the memory system may determine that all data within the die 405-b (e.g., data associated with each page stripe 415 within the die 405-b, data associated with each plane index within the die 405-b) is associated with an error 420 (e.g., an uncorrectable error). In accordance with examples described herein, the memory system may initiate a turbo RAIN recovery operation to recover the entire die 405-b. That is, because the die-level failure results in multiple errors in each page stripe 415, the memory system may determine to select a turbo RAIN recovery operation over a RAIN recovery operation. In some examples, the memory system may identify multiple errors across page stripes 415, across block stripes, or a combination thereof.

The memory system may perform a die rebuild operation of the die 405-b in accordance with one or more turbo RAIN techniques described herein. For example, the memory system may perform an iterative error recovery operation, where the memory system recovers each of the page stripes 415, one after another, each in accordance with a turbo RAIN recovery operation (e.g., a die-based turbo RAIN recovery operations, as described with reference to FIG. 2 or a plane-based turbo RAIN recovery operation, as described with reference to FIG. 3). The memory system may correct errors 420 associated with the page stripe 415-a based on one or more first reference values stored at a reference buffer, followed by correcting errors 420 associated with the page stripe 415-b based on one or more second reference values stored at the reference buffer, followed by correcting errors 420 associated with the page stripe 415-c based on one or more third reference values stored at the reference buffer, and finally correcting errors 420 associated with the page stripe 415-d based on one or more fourth reference values stored at the reference buffer. By rebuilding the die 405-b in accordance with the turbo RAIN techniques using the stored reference values as described herein, the memory system may support a faster rate of die rebuilding operations (e.g., die recovery), which may result in reduced down times of the memory system, more efficient memory access, and reduced latencies.

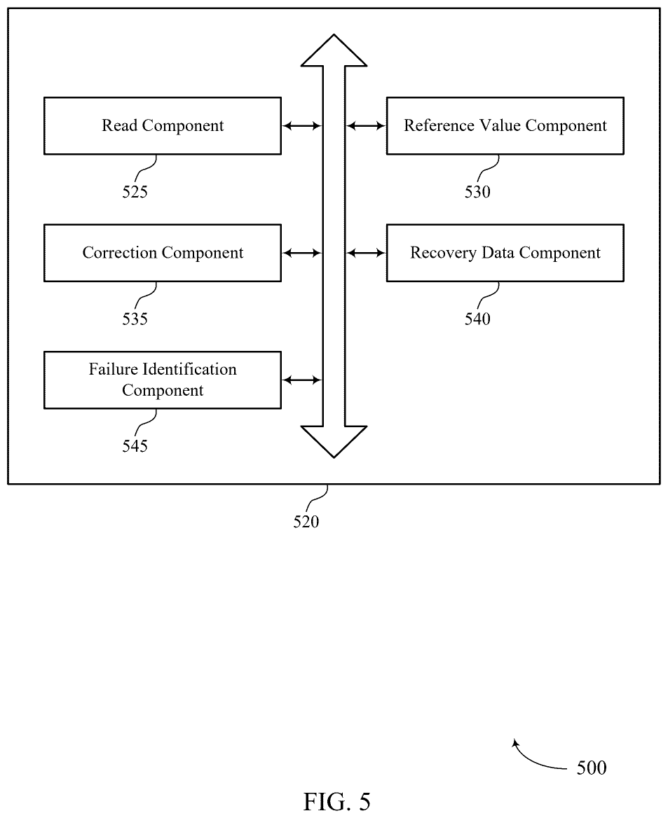

FIG. 5 shows a block diagram 500 of a memory system 520 that supports turbo RAIN operations across planes of a memory system in accordance with examples as disclosed herein. The memory system 520 may be an example of aspects of a memory system as described with reference to FIGS. 1 through 4. The memory system 520, or various components thereof, may be an example of means for performing various aspects of turbo RAIN operations across planes of a memory system as described herein. For example, the memory system 520 may include a read component 525, a reference value component 530, a correction component 535, a recovery data component 540, a failure identification component 545, or any combination thereof. Each of these components, or components of subcomponents thereof (e.g., one or more processors, one or more memories), may communicate, directly or indirectly, with one another (e.g., via one or more buses).

The read component 525 may be configured as or otherwise support a means for reading data from a page stripe of the memory system, the data stored in a first set of data transfer units within the page stripe and a second set of data transfer units within the page stripe that is different than the first set of data transfer units, the first set of data transfer units storing a first subset of the data that is associated with one or more errors. The reference value component 530 may be configured as or otherwise support a means for storing, based at least in part on the first set of data transfer units including at least two data transfer units associated with the one or more errors, a reference value associated with recovery of the first subset of the data within the page stripe, where the reference value is based at least in part on a second subset of the data that is stored in the second set of data transfer units. The correction component 535 may be configured as or otherwise support a means for correcting, based at least in part on the stored reference value and first recovery data associated with the first set of data transfer units, a first error of the one or more errors. In some examples, the correction component 535 may be configured as or otherwise support a means for correcting, based at least in part on the stored reference value and second recovery data associated with the first set of data transfer units, a second error of the one or more errors.

In some examples, to support reading the data from the page stripe, the read component 525 may be configured as or otherwise support a means for reading the data from a plurality of planes of the page stripe across a plurality of memory dies of the memory system, where each memory die includes at least one plane associated with a first plane index, the first set of data transfer units and the second set of data transfer units within one or more planes on one or more memory dies of the page stripe that are associated with the first plane index, and where the stored reference value is associated with the first plane index.

In some examples, the reference value component 530 may be configured as or otherwise support a means for storing, in at least one data transfer unit of a plane that is associated with the first plane index and is included in a final memory die of the plurality of memory dies, information that indicates a first combination of the first subset of the data and the second subset of the data, where the reference value is based at least in part on a second combination of the second subset of the data that is stored in the second set of data transfer units and the stored information.

In some examples, the failure identification component 545 may be configured as or otherwise support a means for identifying that a memory die of the plurality of memory dies is associated with a die-level failure, where at least one data transfer unit of the first set of data transfer units storing the first subset of the data is within the memory die. In some examples, the correction component 535 may be configured as or otherwise support a means for performing a recovery of the memory die based at least in part on the stored reference value and one or more second reference values associated with one or more second plane indexes, where performing the recovery of the memory die includes recovering the first subset of the data based at least in part on the stored reference value and recovering second data within the memory die based at least in part on the one or more second reference values.

In some examples, to support reading the data from the page stripe, the read component 525 may be configured as or otherwise support a means for reading the data from the first set of data transfer units and the second set of data transfer units within a plurality of planes of the page stripe and across a plurality of memory dies of the memory system, where each memory die includes one or more planes associated with one or more plane indexes, and where the stored reference value is associated with a page stripe index of the page stripe.

In some examples, the reference value component 530 may be configured as or otherwise support a means for storing, in at least one data transfer unit of a final plane of the plurality of planes of the page stripe, information that indicates a first combination of the data stored across the first set of data transfer units and the second set of data transfer units, where the reference value is based at least in part on a second combination of the second subset of the data that is stored in the second set of data transfer units and the stored information.

In some examples, to support storing the reference value, the reference value component 530 may be configured as or otherwise support a means for storing the reference value for a duration, where the first error and the second error are corrected before an expiration of the duration. In some examples, to support storing the reference value, the reference value component 530 may be configured as or otherwise support a means for overwriting, based at least in part on the duration expiring, the reference value with a second reference value associated with recovery of second data stored in a third set of data transfer units.

In some examples, the reference value component 530 may be configured as or otherwise support a means for generating the reference value based at least in part on a combination of respective data from each data transfer unit of the second set of data transfer units in accordance with a logical operation, where storing the reference value is based at least in part on the generating.

In some examples, the recovery data component 540 may be configured as or otherwise support a means for generating the first recovery data for recovery of the first error within a first data transfer unit of the first set of data transfer units, where generating the first recovery data is based at least in part on a first combination of a first subset of the first set of data transfer units that is different than the first data transfer unit, and where correcting the first error is based at least in part on a second combination of the reference value with the first recovery data. In some examples, the recovery data component 540 may be configured as or otherwise support a means for generating the second recovery data for recovery of the second error within a second data transfer unit of the first set of data transfer units, where generating the second recovery data is based at least in part on a third combination of a second subset of the first set of data transfer units that is different than the second data transfer unit, and where correcting the second error is based at least in part on a fourth combination of the reference value with the second recovery data.

In some examples, the read component 525 may be configured as or otherwise support a means for receiving a command to read the data from the page stripe of the memory system, where reading the data is based at least in part on the command. In some examples, the read component 525 may be configured as or otherwise support a means for transmitting the data responsive to the command based at least in part on correcting the first error and correcting the second error.

In some examples, the correction component 535 may be configured as or otherwise support a means for performing an error correction operation based at least in part on reading the data from the page stripe of the memory system. In some examples, the correction component 535 may be configured as or otherwise support a means for detecting the one or more errors associated with the first subset of the data based at least in part on performing the error correction operation.

In some examples, the correction component 535 may be configured as or otherwise support a means for initiating a RAIN recovery operation based at least in part on reading the data from the page stripe of the memory system, where storing the reference value is based at least in part on a failure associated with the RAIN recovery operation, and where correcting the first error and the second error is in accordance with a turbo RAIN recovery operation different from the RAIN recovery operation.

In some examples, the one or more errors include a plurality of uncorrectable errors.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

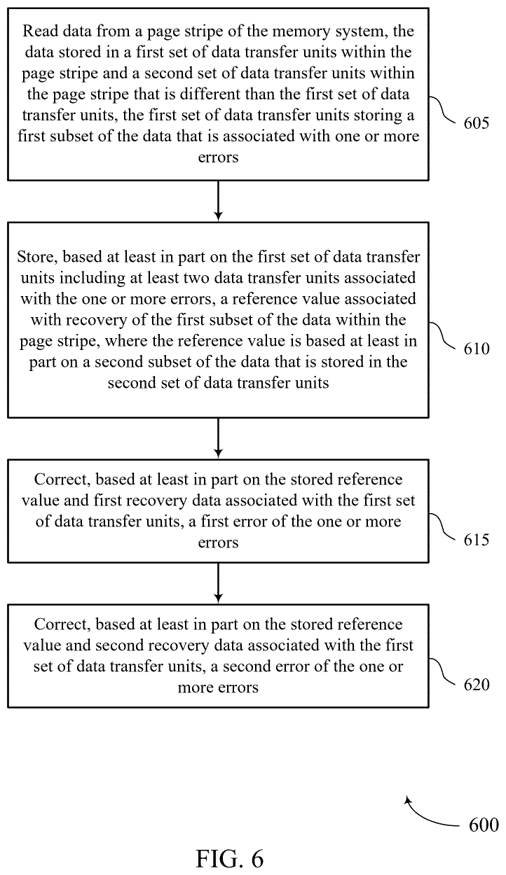

FIG. 6 shows a flowchart illustrating a method 600 that supports turbo RAIN operations across planes of a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include reading data from a page stripe of the memory system, the data stored in a first set of data transfer units within the page stripe and a second set of data transfer units within the page stripe that is different than the first set of data transfer units, the first set of data transfer units storing a first subset of the data that is associated with one or more errors. In some examples, aspects of the operations of 605 may be performed by a read component 525 as described with reference to FIG. 5.

At 610, the method may include storing, based at least in part on the first set of data transfer units including at least two data transfer units associated with the one or more errors, a reference value associated with recovery of the first subset of the data within the page stripe, where the reference value is based at least in part on a second subset of the data that is stored in the second set of data transfer units. In some examples, aspects of the operations of 610 may be performed by a reference value component 530 as described with reference to FIG. 5.

At 615, the method may include correcting, based at least in part on the stored reference value and first recovery data associated with the first set of data transfer units, a first error of the one or more errors. In some examples, aspects of the operations of 615 may be performed by a correction component 535 as described with reference to FIG. 5.

At 620, the method may include correcting, based at least in part on the stored reference value and second recovery data associated with the first set of data transfer units, a second error of the one or more errors. In some examples, aspects of the operations of 620 may be performed by a correction component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for reading data from a page stripe of the memory system, the data stored in a first set of data transfer units within the page stripe and a second set of data transfer units within the page stripe that is different than the first set of data transfer units, the first set of data transfer units storing a first subset of the data that is associated with one or more errors; storing, based at least in part on the first set of data transfer units including at least two data transfer units associated with the one or more errors, a reference value associated with recovery of the first subset of the data within the page stripe, where the reference value is based at least in part on a second subset of the data that is stored in the second set of data transfer units; correcting, based at least in part on the stored reference value and first recovery data associated with the first set of data transfer units, a first error of the one or more errors; and correcting, based at least in part on the stored reference value and second recovery data associated with the first set of data transfer units, a second error of the one or more errors.

Aspect 2: The method, apparatus, or non-transitory computer-readable medium of aspect 1, where reading the data from the page stripe includes operations, features, circuitry, logic, means, or instructions, or any combination thereof for reading the data from a plurality of planes of the page stripe across a plurality of memory dies of the memory system, where each memory die includes at least one plane associated with a first plane index, the first set of data transfer units and the second set of data transfer units within one or more planes on one or more memory dies of the page stripe that are associated with the first plane index, and where the stored reference value is associated with the first plane index.

Aspect 3: The method, apparatus, or non-transitory computer-readable medium of aspect 2, further including operations, features, circuitry, logic, means, or instructions, or any combination thereof for storing, in at least one data transfer unit of a plane that is associated with the first plane index and is included in a final memory die of the plurality of memory dies, information that indicates a first combination of the first subset of the data and the second subset of the data, where the reference value is based at least in part on a second combination of the second subset of the data that is stored in the second set of data transfer units and the stored information.

Aspect 4: The method, apparatus, or non-transitory computer-readable medium of any of aspects 2 through 3, further including operations, features, circuitry, logic, means, or instructions, or any combination thereof for identifying that a memory die of the plurality of memory dies is associated with a die-level failure, where at least one data transfer unit of the first set of data transfer units storing the first subset of the data is within the memory die and performing a recovery of the memory die based at least in part on the stored reference value and one or more second reference values associated with one or more second plane indexes, where performing the recovery of the memory die includes recovering the first subset of the data based at least in part on the stored reference value and recovering second data within the memory die based at least in part on the one or more second reference values.

Aspect 5: The method, apparatus, or non-transitory computer-readable medium of any of aspects 1 through 4, where reading the data from the page stripe includes operations, features, circuitry, logic, means, or instructions, or any combination thereof for reading the data from the first set of data transfer units and the second set of data transfer units within a plurality of planes of the page stripe and across a plurality of memory dies of the memory system, where each memory die includes one or more planes associated with one or more plane indexes, and where the stored reference value is associated with a page stripe index of the page stripe.

Aspect 6: The method, apparatus, or non-transitory computer-readable medium of aspect 5, further including operations, features, circuitry, logic, means, or instructions, or any combination thereof for storing, in at least one data transfer unit of a final plane of the plurality of planes of the page stripe, information that indicates a first combination of the data stored across the first set of data transfer units and the second set of data transfer units, where the reference value is based at least in part on a second combination of the second subset of the data that is stored in the second set of data transfer units and the stored information.

Aspect 7: The method, apparatus, or non-transitory computer-readable medium of any of aspects 1 through 6, where storing the reference value includes operations, features, circuitry, logic, means, or instructions, or any combination thereof for storing the reference value for a duration, where the first error and the second error are corrected before an expiration of the duration and overwriting, based at least in part on the duration expiring, the reference value with a second reference value associated with recovery of second data stored in a third set of data transfer units.

Aspect 8: The method, apparatus, or non-transitory computer-readable medium of any of aspects 1 through 7, further including operations, features, circuitry, logic, means, or instructions, or any combination thereof for generating the reference value based at least in part on a combination of respective data from each data transfer unit of the second set of data transfer units in accordance with a logical operation, where storing the reference value is based at least in part on the generating.

Aspect 9: The method, apparatus, or non-transitory computer-readable medium of any of aspects 1 through 8, further including operations, features, circuitry, logic, means, or instructions, or any combination thereof for generating the first recovery data for recovery of the first error within a first data transfer unit of the first set of data transfer units, where generating the first recovery data is based at least in part on a first combination of a first subset of the first set of data transfer units that is different than the first data transfer unit, and where correcting the first error is based at least in part on a second combination of the reference value with the first recovery data and generating the second recovery data for recovery of the second error within a second data transfer unit of the first set of data transfer units, where generating the second recovery data is based at least in part on a third combination of a second subset of the first set of data transfer units that is different than the second data transfer unit, and where correcting the second error is based at least in part on a fourth combination of the reference value with the second recovery data.

Aspect 10: The method, apparatus, or non-transitory computer-readable medium of any of aspects 1 through 9, further including operations, features, circuitry, logic, means, or instructions, or any combination thereof for receiving a command to read the data from the page stripe of the memory system, where reading the data is based at least in part on the command and transmitting the data responsive to the command based at least in part on correcting the first error and correcting the second error.

Aspect 11: The method, apparatus, or non-transitory computer-readable medium of any of aspects 1 through 10, further including operations, features, circuitry, logic, means, or instructions, or any combination thereof for performing an error correction operation based at least in part on reading the data from the page stripe of the memory system and detecting the one or more errors associated with the first subset of the data based at least in part on performing the error correction operation.

Aspect 12: The method, apparatus, or non-transitory computer-readable medium of any of aspects 1 through 11, further including operations, features, circuitry, logic, means, or instructions, or any combination thereof for initiating a RAIN recovery operation based at least in part on reading the data from the page stripe of the memory system, where storing the reference value is based at least in part on a failure associated with the RAIN recovery operation, and where correcting the first error and the second error is in accordance with a turbo RAIN recovery operation different from the RAIN recovery operation.

Aspect 13: The method, apparatus, or non-transitory computer-readable medium of any of aspects 1 through 12, where the one or more errors include a plurality of uncorrectable errors.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
read data from a page stripe of the memory system, the data stored in a first set of data transfer units within the page stripe and a second set of data transfer units within the page stripe that is different than the first set of data transfer units, the first set of data transfer units storing a first subset of the data that is associated with one or more errors;
store, based at least in part on the first set of data transfer units including at least two data transfer units associated with the one or more errors, a reference value associated with recovery of the first subset of the data within the page stripe, wherein the reference value is based at least in part on a second subset of the data that is stored in the second set of data transfer units;
correct, based at least in part on the stored reference value and first recovery data associated with the first set of data transfer units, a first error of the one or more errors; and
correct, based at least in part on the stored reference value and second recovery data associated with the first set of data transfer units, a second error of the one or more errors.

2. The memory system of claim 1, wherein, to read the data from the page stripe, the processing circuitry is further configured to cause the memory system to:
read the data from a plurality of planes of the page stripe across a plurality of memory dies of the memory system, wherein each memory die comprises at least one plane associated with a first plane index, the first set of data transfer units and the second set of data transfer units within one or more planes on one or more memory dies of the page stripe that are associated with the first plane index, and wherein the stored reference value is associated with the first plane index.

3. The memory system of claim 2, wherein the processing circuitry is further configured to cause the memory system to:
store, in at least one data transfer unit of a plane that is associated with the first plane index and is included in a final memory die of the plurality of memory dies, information that indicates a first combination of the first subset of the data and the second subset of the data, wherein the reference value is based at least in part on a second combination of the second subset of the data that is stored in the second set of data transfer units and the stored information.

4. The memory system of claim 2, wherein the processing circuitry is further configured to cause the memory system to:
identify that a memory die of the plurality of memory dies is associated with a die-level failure, wherein at least one data transfer unit of the first set of data transfer units storing the first subset of the data is within the memory die; and
perform a recovery of the memory die based at least in part on the stored reference value and one or more second reference values associated with one or more second plane indexes, wherein performing the recovery of the memory die comprises recovering the first subset of the data based at least in part on the stored reference value and recovering second data within the memory die based at least in part on the one or more second reference values.

5. The memory system of claim 1, wherein, to read the data from the page stripe, the processing circuitry is further configured to cause the memory system to:
read the data from the first set of data transfer units and the second set of data transfer units within a plurality of planes of the page stripe and across a plurality of memory dies of the memory system, wherein each memory die comprises one or more planes associated with one or more plane indexes, and wherein the stored reference value is associated with a page stripe index of the page stripe.

6. The memory system of claim 5, wherein the processing circuitry is further configured to cause the memory system to:
store, in at least one data transfer unit of a final plane of the plurality of planes of the page stripe, information that indicates a first combination of the data stored across the first set of data transfer units and the second set of data transfer units, wherein the reference value is based at least in part on a second combination of the second subset of the data that is stored in the second set of data transfer units and the stored information.

7. The memory system of claim 1, wherein, to store the reference value, the processing circuitry is further configured to cause the memory system to:
store the reference value for a duration, wherein the first error and the second error are corrected before an expiration of the duration; and
overwrite, based at least in part on the duration expiring, the reference value with a second reference value associated with recovery of second data stored in a third set of data transfer units.

8. The memory system of claim 1, wherein the processing circuitry is further configured to cause the memory system to:
generate the reference value based at least in part on a combination of respective data from each data transfer unit of the second set of data transfer units in accordance with a logical operation, wherein storing the reference value is based at least in part on the generating.

9. The memory system of claim 1, wherein the processing circuitry is further configured to cause the memory system to:
generate the first recovery data for recovery of the first error within a first data transfer unit of the first set of data transfer units, wherein generating the first recovery data is based at least in part on a first combination of a first subset of the first set of data transfer units that is different than the first data transfer unit, and wherein correcting the first error is based at least in part on a second combination of the reference value with the first recovery data; and
generate the second recovery data for recovery of the second error within a second data transfer unit of the first set of data transfer units, wherein generating the second recovery data is based at least in part on a third combination of a second subset of the first set of data transfer units that is different than the second data transfer unit, and wherein correcting the second error is based at least in part on a fourth combination of the reference value with the second recovery data.

10. The memory system of claim 1, wherein the processing circuitry is further configured to cause the memory system to:
receive a command to read the data from the page stripe of the memory system, wherein reading the data is based at least in part on the command; and
transmit the data responsive to the command based at least in part on correcting the first error and correcting the second error.

11. The memory system of claim 1, wherein the processing circuitry is further configured to cause the memory system to:
perform an error correction operation based at least in part on reading the data from the page stripe of the memory system; and
detect the one or more errors associated with the first subset of the data based at least in part on performing the error correction operation.

12. The memory system of claim 1, wherein the processing circuitry is further configured to cause the memory system to:
initiate a redundant array of independent not-and (RAIN) recovery operation based at least in part on reading the data from the page stripe of the memory system, wherein storing the reference value is based at least in part on a failure associated with the RAIN recovery operation, and wherein correcting the first error and the second error is in accordance with a turbo RAIN recovery operation different from the RAIN recovery operation.

13. The memory system of claim 1, wherein the one or more errors comprise a plurality of uncorrectable errors.

14. A method by a memory system, comprising:
reading data from a page stripe of the memory system, the data stored in a first set of data transfer units within the page stripe and a second set of data transfer units within the page stripe that is different than the first set of data transfer units, the first set of data transfer units storing a first subset of the data that is associated with one or more errors;
storing, based at least in part on the first set of data transfer units including at least two data transfer units associated with the one or more errors, a reference value associated with recovery of the first subset of the data within the page stripe, wherein the reference value is based at least in part on a second subset of the data that is stored in the second set of data transfer units;
correcting, based at least in part on the stored reference value and first recovery data associated with the first set of data transfer units, a first error of the one or more errors; and
correcting, based at least in part on the stored reference value and second recovery data associated with the first set of data transfer units, a second error of the one or more errors.

15. The method of claim 14, wherein reading the data from the page stripe comprises:
reading the data from a plurality of planes of the page stripe across a plurality of memory dies of the memory system, wherein each memory die comprises at least one plane associated with a first plane index, the first set of data transfer units and the second set of data transfer units within one or more planes on one or more memory dies of the page stripe that are associated with the first plane index, and wherein the stored reference value is associated with the first plane index.

16. The method of claim 15, further comprising:
storing, in at least one data transfer unit of a plane that is associated with the first plane index and is included in a final memory die of the plurality of memory dies, information that indicates a first combination of the first subset of the data and the second subset of the data, wherein the reference value is based at least in part on a second combination of the second subset of the data that is stored in the second set of data transfer units and the stored information.

17. The method of claim 15, further comprising:
identifying that a memory die of the plurality of memory dies is associated with a die-level failure, wherein at least one data transfer unit of the first set of data transfer units storing the first subset of the data is within the memory die; and
performing a recovery of the memory die based at least in part on the stored reference value and one or more second reference values associated with one or more second plane indexes, wherein performing the recovery of the memory die comprises recovering the first subset of the data based at least in part on the stored reference value and recovering second data within the memory die based at least in part on the one or more second reference values.

18. The method of claim 14, wherein reading the data from the page stripe comprises:
reading the data from the first set of data transfer units and the second set of data transfer units within a plurality of planes of the page stripe and across a plurality of memory dies of the memory system, wherein each memory die comprises one or more planes associated with one or more plane indexes, and wherein the stored reference value is associated with a page stripe index of the page stripe.

19. The method of claim 18, further comprising:
storing, in at least one data transfer unit of a final plane of the plurality of planes of the page stripe, information that indicates a first combination of the data stored across the first set of data transfer units and the second set of data transfer units, wherein the reference value is based at least in part on a second combination of the second subset of the data that is stored in the second set of data transfer units and the stored information.

20. The method of claim 14, wherein storing the reference value comprises:
storing the reference value for a duration, wherein the first error and the second error are corrected before an expiration of the duration; and
overwriting, based at least in part on the duration expiring, the reference value with a second reference value associated with recovery of second data stored in a third set of data transfer units.

21. The method of claim 14, further comprising:
generating the reference value based at least in part on a combination of respective data from each data transfer unit of the second set of data transfer units in accordance with a logical operation, wherein storing the reference value is based at least in part on the generating.

22. The method of claim 14, further comprising:
generating the first recovery data for recovery of the first error within a first data transfer unit of the first set of data transfer units, wherein generating the first recovery data is based at least in part on a first combination of a first subset of the first set of data transfer units that is different than the first data transfer unit, and wherein correcting the first error is based at least in part on a second combination of the reference value with the first recovery data; and
generating the second recovery data for recovery of the second error within a second data transfer unit of the first set of data transfer units, wherein generating the second recovery data is based at least in part on a third combination of a second subset of the first set of data transfer units that is different than the second data transfer unit, and wherein correcting the second error is based at least in part on a fourth combination of the reference value with the second recovery data.

23. The method of claim 14, further comprising:
receiving a command to read the data from the page stripe of the memory system, wherein reading the data is based at least in part on the command; and
transmitting the data responsive to the command based at least in part on correcting the first error and correcting the second error.

24. A non-transitory computer-readable medium storing code, the code comprising instructions executable by one or more processors to:
read data from a page stripe of a memory system, the data stored in a first set of data transfer units within the page stripe and a second set of data transfer units within the page stripe that is different than the first set of data transfer units, the first set of data transfer units storing a first subset of the data that is associated with one or more errors;
store, based at least in part on the first set of data transfer units including at least two data transfer units associated with the one or more errors, a reference value associated with recovery of the first subset of the data within the page stripe, wherein the reference value is based at least in part on a second subset of the data that is stored in the second set of data transfer units;
correct, based at least in part on the stored reference value and first recovery data associated with the first set of data transfer units, a first error of the one or more errors; and
correct, based at least in part on the stored reference value and second recovery data associated with the first set of data transfer units, a second error of the one or more errors.

25. The non-transitory computer-readable medium of claim 24, wherein, to read the data from the page stripe, the instructions are executable by the one or more processors to:
read the data from a plurality of planes of the page stripe across a plurality of memory dies of the memory system, wherein each memory die comprises at least one plane associated with a first plane index, the first set of data transfer units and the second set of data transfer units within one or more planes on one or more memory dies of the page stripe that are associated with the first plane index, and wherein the stored reference value is associated with the first plane index.
